(19) United States
(12) Patent Application Publication
(10) Pub. No.: US 2005/0125412 A1
(43) Pub. Date: Jun. 9, 2005

(54) Web crawling

(75) Inventor: Eric J. Glover, North Brunswick, NJ (US)

Correspondence Address: NEC Laboratories America, Inc., 4 Independence Way, Princeton, NJ, 08540, US

(73) Assignee: NEC Laboratories America, Inc., Princeton, NJ (US)

(21) Appl. No.: 10/807,698

(22) Filed: Mar. 24, 2004

Related U.S. Application Data
(60) Provisional application No. 60/528,071, filed on Dec. 9, 2003.

(51) Int. Cl. G06F 7/00

(52) U.S. Cl. 707/10

(57) ABSTRACT

The present invention is directed to mechanisms for improving the “crawling” of resources on a network, which takes into account the notion of browser state. An improved indexing scheme for the crawled results and improved search mechanisms are also disclosed.

This Utility Patent Application is a Non-Provisional of and claims the benefit of U.S. Provisional Patent Application Ser. No. 60/528,071 entitled “IMPROVED WEB CRAWLING” filed on Dec. 9, 2003, the contents of which are incorporated by reference herein.

### BACKGROUND OF THE INVENTION

The present invention relates to information retrieval and, more particularly, to automated “crawling” techniques for retrieving information on a network.

A vast array of content can be retrieved from servers across a large network such as the Internet. Typically, such content is embodied in documents referred to colloquially as “web pages” created using a markup language such as the Hypertext Markup Language (HTML) and retrieved by a client “browser” using a protocol such as the Hypertext Transfer Protocol (HTTP). See, e.g., R. Fielding et al., “Hypertext Transfer Protocol—HTTP/1.1,” Internet Engineering Task Force (IETF), Request for Comments (RFC) 2616 (June 1999); T. Berners-Lee, D. Connolly, “Hypertext Markup Language,” IETF, RFC 1866 (November 1995). Such documents on the World Wide Web are typically identified using a Uniform Resource Locator (URL), e.g., in the form “http://www.example.com/dir/page.html”. See T. Berners-Lee, “Uniform Resource Identifiers in WWW,” IETF, Network Working Group, RFC 1630 (June 1994); T. Berners-Lee, L. Masinter, M. McCahill, eds., “Uniform Resource Locators (URL),” IETF, Network Working Group, RFC 1738 (December 1994). Given the large amount of content available on the Internet, it has become advantageous to provide searchable databases of content and/or content metadata. A typical search engine on the Internet today operates by a process referred to as “crawling” web pages, whereby a large number of documents are automatically retrieved and stored for analysis and indexing.

Recently, it has become common for many popular web servers to return multiple versions of content for the same URL. This is typically accomplished through the use of “browser state” and can be used, for example, to customize the web page to particular languages or to reflect some personal preferences of the user of the client browser. Unfortunately, typical search engines only offer a single “browser state” and are unable to “see” the different content associated with the same URL. The problem is made worse in that most search engines index the “crawled” web pages by URL alone, which typically permits storing only one copy of a given web page. Even if a search engine crawler by coincidence retrieves the different content, the search engine typically must select only one of the multiple versions of content to associate with the particular URL. The problem is manifest by the fact that a searching user, who has a “browser state” different from that of the crawler used to find a given page, might click on a result and not find the correct contents identified by the search engine—or in fact might never be able to find the correct results because the crawler was unable to find the documents associated with a state different from their own.

### SUMMARY OF THE INVENTION

The present invention is directed to an improved technique for “crawling” for resources, such as web pages, in a network. An improved crawler is disclosed which is modified to fetch at least one page (and possibly all pages) with a different browser state. As discussed in further detail herein, the browser state can represent a variety of different parameters/information about a client browser to a server, such as a language or locale preference, a reported browser-string, a geographic location (e.g. based on the IP address or locale settings of the browser) or other factors.

The present invention is also directed to an improved scheme for storing and/or indexing the crawled results and for searching through the results. A database can be readily constructed in which a combination of the uniform resource locator and the browser state is utilized as an identifier. Hence, the same uniform resource locator could be saved more than once in the database, once for each different browser state. When a user performs a search, the user's browser state can be used to select the matching pages.

These and other advantages of the invention will be apparent to those of ordinary skill in the art by reference to the following detailed description and the accompanying drawings.

### BRIEF DESCRIPTION OF DRAWINGS

FIG. 1 shows a client host in communication with a server host in accordance with the prior art.

FIG. 2 shows a client host in communication with a server host in accordance with an embodiment of an aspect of the invention.

FIG. 3 is a flowchart of processing performed by a crawler, in accordance with an embodiment of this aspect of the invention.

FIG. 4 is a flowchart of processing performed by a search engine, in accordance with an embodiment of this aspect of the invention.

### DETAILED DESCRIPTION OF THE INVENTION

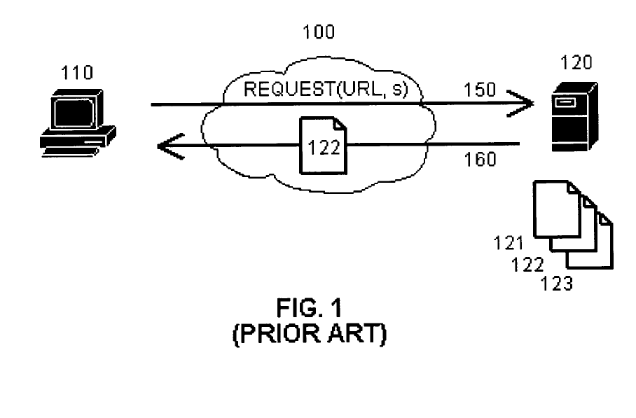

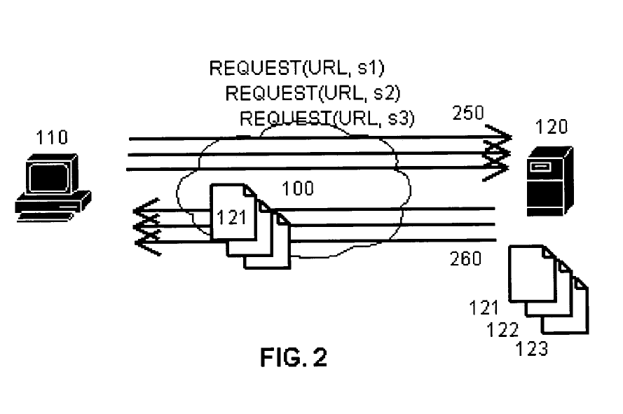

In FIG. 1 and 2, a client host 110 is shown in communication through a network 100 with a server host 120. It is assumed without limitation that the client host 110 is executing some crawler application and that the server host 120 is executing some server application that provides the crawler application access to various resources stored at the server or accessible to the server. For example, and without limitation, the server application can be an HTTP server, such as APACHE, and the crawler application can be a script that issues a series of HTTP client requests. It is also assumed that the communication network 100 provides connectivity using some advantageous protocol, such as TCP/IP. It should be noted that the present invention is not limited to any such particular communication protocol or to any such particular crawler application or client-server architecture.

The crawler application automatically requests a variety of resources stored on one or more server hosts connected to the network. The present invention is not limited to any particular type of resource, although the present invention is of particular interest in “crawling” pages composed in some markup language such as HTML or XML. For purposes of illustration and discussion only, the different resources shall be referred to also as “pages” herein. The resources are typically identified by what the inventors refer to generically as uniform resource locators. A uniform resource locator, for purposes of the present invention, can be any advantageous representation or identifier of the “location” of the resource in the network for use by the crawler and other client applications. The present invention is not limited to any particular form of uniform resource locator. For example, in the context of the World Wide Web, the uniform resource locator can be a conventional URL such as “http://www.example.com/dir/page.html” where “http:” represents the particular retrieval methodology, “www.example.com” represents an identification of the server host (or alternatively by network address depending on whether address translation facilities are available), and “/dir/page.html” represents a directory tree path and document identifier for the resource on the server host. See T. Berners-Lee, “Uniform Resource Identifiers in WWW,” IETF, Network Working Group, RFC 1630 (June 1994); T. Berners-Lee, L. Masinter, M. McCahill, eds., “Uniform Resource Locators (URL),” IETF, Network Working Group, RFC 1738 (December 1994), which are incorporated by reference herein.

It is assumed that the network provides access to a collection of pages, p1, p2, p3, etc. . . . , with each corresponding to a uniform resource locator U1, U2, U3, . . . Un. In the prior art, it is generally assumed that at a given specific time a particular uniform resource locator will correspond to a unique page, i.e. that U1→p1, U2→p2, etc. The pages may change over time, or even be dropped resulting in a “dead” link, but the correspondence between a uniform resource locator and a resource is typically assumed. A conventional prior art crawler, accordingly, will operate as follows:
for each URL
page-contents=request(URL),
with state s as a constant for all URLs and pages.

Unfortunately, the client state may affect the mapping, so that (U1, s1)→p1, (U1, s2)→p1_2, (U1, s3)→p1_3, . . . and so on, where p1 may be different from p1_2 and p1_3.

For example, as depicted in FIG. 1, the crawler on the client host 110 sends a request 150 to the server host 120 for a particular URL. The server 120 receives the request and responds at 160 to the request by selecting one out of a plurality of pages 121, 122, 123, depending on the particular request and state s of the client. The “state” of the client can refer to any of a collection of parameters or information available to the server host 120 about the client application/host. For example, and without limitation, a conventional browser has a variety of “voluntary” settings that can be identified by a server application, such as type of client browser, preferred language or locale, etc. There are also “external” factors that can be identified by a server, such as the client's network address (IP address) which is a property not directly settable by a client application. All of these different forms of information available to the server host 120 are defined as state “s” and the state is assumed to contain any one or more of these parameters.

A crawler operating in accordance with an embodiment of an aspect of the invention would operate as follows:
for each URL,
for each state s in (s1, s2, . . . , sn)
page-contents_n=request(URL,s_n).

As a result, there can be several copies of page contents for each given URL. This is depicted in FIG. 2. The crawler on the client host 110 in FIG. 2 sends multiple requests 250 to the server host 120 for the same URL. Where the different states s1, s2, s3 can be represented using “voluntary” settings, the client host 110 can readily vary the requests to reflect different browser state. Where the different states s1, s2, s3 reflect “external” factors, it may be necessary to execute different crawlers on different hosts reflecting the different external factors. The server 120 receives the different requests and responds at 260 to the requests by selecting each of the different pages 121, 122, 123, depending on the particular state s in the specific crawler request.

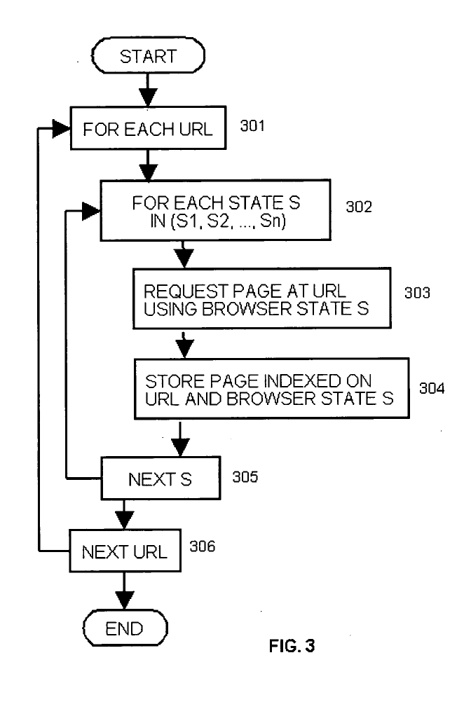

FIG. 3 is a flowchart of the processing performed by a crawler, in accordance with an embodiment of this aspect of the invention. At step 301, the crawler processes the next URL in a list of URLs. As is known in the art of crawlers, the list can be generated by specifying some popular websites and extracting further URL links from each page retrieved. At step 302, the crawler selects a state s from a collection of advantageously-defined states. The crawler can be implemented to select every state variation for every URL or, more preferably, can be implemented to be selective as to which states are varied and for which URLs. At step 303, the crawler issues a request for the resource at the URL modified to reflect the selected state s. For example, an illustrative HTTP request for the URL “http://www.example.com/dir/page.html” would look similar to the following:
GET /dir/page.html HTTP/1.1
Host: www.example.com
Accept: */*
Accept-Languages: en-us
User-Agent: Mozilla/4.0 (compatible; MSIE 6.0; Windows NT 5.0)
   See, e.g., R. Fielding et al., “Hypertext Transfer Protocol—HTTP/1.1,” Internet Engineering Task Force (IETF), Request for Comments (RFC) 2616 (June 1999). The “Accept-Languages” option specifies “en-us” (English speakers in United States) and could be readily varied to other languages or locales. See, e.g., H. Alvestrand, “IETF Policy on Character Sets and Languages,” IETF Network Working Group, RFC 2277 (January 1998); H. Alvestrand, “Tags for the Identification of Languages,” IETF Network Working Group, RFC 3066 (January 2001), the contents of which are incorporated by reference herein. The “browser string” shown in the “User-Agent” option specifies the type of browser (here Microsoft Internet Explorer) and could be readily varied to other types of browsers, such as Netscape or a cell-phone enabled browser.

At step 304, the crawler receives the requested resource and proceeds to store and process the resource. In accordance with an embodiment of another aspect of the invention, it is advantageous to index the resource by browser state as well as by URL. In other words, instead of indexing the resource as follows:
Add-to-database(URL, page-contents)
   it is preferable to index the resource as follows:
for each state s in (s1, s2, . . . , sn)
Add-to-database(URL, s_n, page-contents_n)
   Thus, each contents of each resource is saved and associated with the URL and with the particular browser state selected for the request.

With reference again to FIG. 3, the next state is selected at step 305 and another request is issued, etc., until the specified states for the particular URL are exhausted. Then, at step 306, the next URL is utilized until the crawler has exhausted all URLs or some crawling threshold has been reached.

After the different URLs U1, U2, U3 are crawled, a database is constructed that would look like the following:
p_1→U1, s1
p1_2→U1, s2
p1_3→U1, s3
p2_1→U2, s1
p2_2→U2, s2
p2_3→U2, s3
   where s1, s2, and s3 represent the different browser states. This is in contrast to a prior art database which would look like:
p1→U1
p2→U2
p3→U3
   There are a variety of improvements within the spirit of the present invention that could be made to the structure of the database created by the crawler. For example, the database could advantageously only save one copy of resources whose contents are the same for every state. Rather than store duplicates of the same content, it is preferable to store a pointer to the contents. If“page-contents1” is the same as “page-contents2”, then the crawler would store only one copy of the page contents and have a pointer stored associating it with the URL(s) and the state(s) that found the content. Even where the two resources are different from each other, the first resource could be stored as normally and the second resource could be stored in a form that preserves only the differences between the first resource and the second resource, for example and without limitation, using some form of“diff” procedure or delta-encoding.

Thus, it is not a requirement in the context of the present invention that all URLs be saved or even crawled for all states. Rather, a logical association should be made between the state and the URL with the page contents for at least some URLs and some states.

Where it is desired to crawl for variations on browser state that rely on what are referred to as “external” factors above, it is advantageous to provide for different crawler architectures. For example, where the server host uses an external factor (such as a network address) as an approximation of geographic location of the client, it is advantageous to implement the crawler as follows:
(a) The crawler can be implemented as a plurality of physically distributed crawlers that feed into a single pool of information. Each distributed crawler can have its own reported state and could index the crawled information separately.
(b) The crawler can be implemented as a centralized crawler with a plurality of physically distributed remote “agents”—acting for example as “proxies” or “points-of-presence” which issue requests on behalf of the centralized crawler. The server host would interact with the crawler's agents and identify the crawler's requests as having the external factors of the particular agent issuing the request.
(c) The crawler can be implemented as a centralized crawler that simply pretends to have a different external factor, e.g., by pretending to be from a different location than it actually is. For example, here are a variety of mechanisms for “faking” a host's network address, such as modifying the network addressing scheme, the domain name system, or the contents of IP packets to reflect different external factors. The requests from the crawler would appear to the host server as if they were coming from a host with the different external factors.

Likewise, there are variations on the above categories, such as distributed implementations of the functions of the centralized crawler described above. Such variations would be encompassed within the scope of the present invention. Different instances of the crawler in different locations may cause some overlap, e.g., pages requested by a crawler in Spain using a browser setting of “es-mx” might be the same as pages requested by crawlers in the United States using a setting of “es-es”. To address such overlapping resources, it may be desirable to unify the different states for more efficient storage. Thus, for example, even if a crawler has been modified to support a wide range of browser states, s1, s2, s3, . . . , s100, the system may be implemented so as to return a response for some set of states, e.g., s1-s50, and another response for the rest, s51-s100. Thus, not all 100 copies would need be stored in the database. It may be preferable to merely store the differences between the copies.

When a user performs a search on the database created by the crawler, conventionally all users would be treated equally with regard to the set of pages that might be returned for a given query. The query results would proceed as follows:
Results=find-relevant-pages(q)
   Even where prior art search engines such as GOOGLE attempt to take into account user language preferences by redirecting, for example, French users to a French GOOGLE domain, all query requests submitted to the French GOOGLE domain would still be treated the same, regardless of browser state. In contrast, and in accordance with an embodiment of another aspect of the invention, the resources matching a particular query can be selected based on state as well. The query can proceed as follows:
Results=find-relevant-pages(q, browser-state)
   where browser-state specifies the state of the browser of the user submitting the query or represents the state specified by the user in the query itself

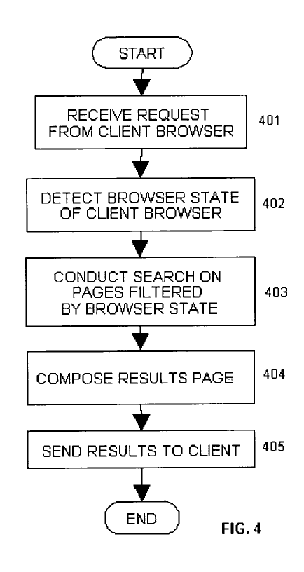

FIG. 4 is a flowchart of processing performed by a search engine, in accordance with an illustrative embodiment of this aspect of the present invention. At step 401, the search engine receives a query request from a client browser. At step 402, the search engine detects the browser state of the client browser. This is accomplished by, for example and without limitation, analyzing the HTTP options in the request, by analyzing the IP address of the client, etc. Then, at step 403, the search engine conducts the search for pages matching the specified query where the results are adjusted based on the detected browser state of the client browser and how it relates to the state of the crawler. Thus, a user browser configured for “English” could receive different search engine results than a user browser configured for “French”. This can be accomplished, for example and without limitation, by filtering pages in the result set to only match those which satisfy the state. Then, at step 404, the search engine composes a page of the results and, at step 405, proceeds to send the results page to the client browser.

For example, consider a search engine which receives a query q1 from a user and which proceeds to determine that the matching results include pages p1_1, p1_2, and p2_3. Recall that a page may be entered multiple times (once for each state) under the above-described new indexing scheme. Assume that the user's browser state is the same as s2 (the fields that are considered by the crawler match that of the crawler state s2). In this case, a simple filter is applied and p1_1 and p2_3 are removed since their associated state was not s2. p1_1 was associated with s1 (the crawler state that found the page) and p2_3 was associated with s3. In the above case, if the results included p2_1 and p2_1=p2_2, then either state s1 or state s2 would allow it to remain since the same page contents were found with more than one state.

It should be noted that it is not required that the filtering occur after the initial results are obtained. The filtering effect can be incorporated into the relevance function or built into the database or indexer. Such variations would be still within the scope of the present invention. For example, and without limitation, consider a query for “XYZ COMPANY” where the user's browser state has been set to “fr-fr” (French/France). A conventional search engine might return results that include “www.xyz.com” as result r1 and “www.xyz.co.fr” are result r2. In accordance with another embodiment of another aspect of the invention, the relevance function can be modified to consider the browser state in the scoring/ranking of results, even where the crawler state was fixed. The ranking of“www.xyz.co.fr” can be altered to come first, because the user's browser has been set to “fr-fr”. Note that the relevance function can be so modified, even if both pages were crawled/found with a fixed (and possibly different from “fr-fr”) browser state.

It should also be noted that a specific implementation might have a default policy when the browser's state does not correspond to a crawler's state. For example, where the search engine receives a request from a browser set for the language of “Swahili” and no crawler was run for that particular state. The policy of the implementation might be to use a default state s1, which might be for example “Language=English, Location=US”. The specific mechanism for selecting default state or for determining which browser state most closely matches (or is considered a match) for a given crawler state (and vice versa) is not relevant to the spirit of the present invention.

It will be appreciated that those skilled in the art will be able to devise numerous arrangements and variations which, although not explicitly shown or described herein, embody the principles of the invention and are within their spirit and scope. For example, and without limitation, the definition of “state” can vary, and the method for dealing with partial state could readily vary, in accordance with the specifications of one of ordinary skill in the art. Also, the present invention has been described with particular reference to HTTP and Web pages. The present invention, nevertheless and as mentioned above, is readily extendable to other protocols and resource types.

1. A method for crawling for resources in a network, the method comprising:
receiving a list of resources on the network and for at least one of the resources on the list of resources,
sending a first request to a server in the network for the resource using a first browser state, and
sending a second request for the same resource using a second browser state.

2. The method of claim 1 wherein the resources are identified by uniform resource locators and wherein the first and second request specify a same uniform resource locator.

3. The method of claim 1 wherein the browser state comprises a language preference.

4. The method of claim 1 wherein the browser state comprises a locale preference.

5. The method of claim 1 wherein the browser state comprises location information.

6. The method of claim 1 wherein the browser state comprises a browser identification.

7. The method of claim 1 wherein the browser state comprises a network address.

8. The method of claim 1 wherein the first request and the second request are issued by a first and second crawler applications that respectively have a first and second browser state.

9. The method of claim 1 wherein the first and second requests are issued by a crawler application that varies its browser state between the first and second requests.

10. A method for processing crawled resources in a network, the method comprising:
receiving a resource in response to a request for the resource using one of a plurality of browser states;
storing the resource; and
indexing the resource, the indexing step further comprising the step of associating the resource with a first browser state where the first browser state is the one of the plurality of browser states used to request the resource.

11. The method of claim 10 wherein resources are identified by uniform resource locators and wherein at least a first resource and a second resource identified by a same uniform resource locator are associated with different browser states.

12. The method of claim 11 wherein the first and second resources are both stored only if the second resource is different from the first resource.

13. The method of claim 12 wherein if the second resource is a duplicate of the first resource, a reference is stored that associates the stored first resource with the second browser state.

14. The method of claim 10 wherein the browser state comprises any one of a group consisting of language preference, locale preference, location information, browser identification, and network address.

15. A method for searching a database of crawled resources, the method comprising the steps of:
receiving a search query from a browser client;
detecting a browser state for the browser client; and
searching for results from the database of resource using both the search query and the browser state of the browser client.

16. The method of claim 15 wherein the database includes at least one record which associates a first resource and a second resource in the database with a same uniform resource locator but with different browser states.

17. The method of claim 15 wherein results that match the search query are filtered using the browser state of the browser client.

18. The method of claim 15 wherein a relevance function is utilized to rank results from search of the database and wherein the relevance function considers the browser state of the browser client in ranking the results.

19. The method of claim 15 wherein if the browser state of the browser client does not match any of the browser states in the database, then a default browser state is used in the search.

20. The method of claim 15 wherein the browser state comprises any one of a group consisting of language preference, locale preference, location information, browser identification, and network address.

21. A computer-readable medium comprising one or more instructions which when executed perform the following:
receiving a list of resources on the network and for at least one of the resources on the list of resources,
sending a first request to a server in the network for a resource using a first browser state, and
sending a second request for the same resource using a second browser state.

22. The computer-readable medium of claim 21 wherein the resources are identified by a uniform resource locator and wherein the first and second request specify a same uniform resource locator.

23. The computer-readable medium of claim 21 wherein the browser state comprises any one of a group consisting of language preference, locale preference, location information, browser identification, and network address.

24. A computer-readable medium comprising one or more instructions which when executed perform the following:
receiving a resource in response to a request for the resource using one of a plurality of browser states;
storing the resource; and
indexing the resource, the indexing step further comprising the step of associating the resource with a first browser state where the first browser state is the one of the plurality of browser states used to request the resource.

25. The computer-readable medium of claim 24 wherein resources are identified by uniform resource locators and wherein at least a first resource and a second resource identified by a same uniform resource locator are associated with different browser states.

26. The computer-readable medium of claim 25 wherein the first and second resources are both stored only if the second resource is different from the first resource.

27. The computer-readable medium of claim 26 wherein if the second resource is a duplicate of the first resource, a reference is stored that associates the stored first resource with the second browser state.

28. The computer-readable medium of claim 24 wherein the browser state comprises any one of a group consisting of language preference, locale preference, location information, browser identification, and network address.

29. A computer-readable medium comprising one or more instructions which when executed perform the following:
receiving a search query from a browser client;
detecting a browser state for the browser client; and
searching for results from the database of resource using both the search query and the browser state of the browser client.

30. The computer-readable medium of claim 29 wherein the database includes at least one record which associates a first resource and a second resource in the database with a same uniform resource locator but with different browser states.

31. The computer-readable medium of claim 29 wherein results that match the search query are filtered using the browser state of the browser client.

32. The computer-readable medium of claim 29 wherein a relevance function is utilized to rank results from search of the database and wherein the relevance function considers the browser state of the browser client in ranking the results.

33. The computer-readable medium of claim 29 wherein if the browser state of the browser client does not match any of the browser states in the database, then a default browser state is used in the search.

34. The computer-readable medium of claim 29 wherein the browser state comprises any one of a group consisting of language preference, locale preference, location information, browser identification, and network address.
